(19) United States
(12) Patent Application Publication
(10) Pub. No.: US 2009/0091915 A1
(43) Pub. Date: Apr. 9, 2009

(54) Illumination device with mechanically adjustable color conversion system

(76) Inventor: Eric O. Eriksson, Glenview, IL (US)

Correspondence Address: ERIC ERIKSSON, 3816 LIZETTE LN, GLENVIEW, IL, 60026, US

(21) Appl. No.: 12/283,693

(22) Filed: Sep. 15, 2008

Related U.S. Application Data
(60) Provisional application No. 60/993,613, filed on Sep. 13, 2007.

(51) Int. Cl. F21V 9/08

(52) U.S. Cl. 362/84

(57) ABSTRACT

A mechanically adjustable color conversion system for illumination devices comprised of light sources oriented linearly or in an array located under a fluorescent dyed clear or defused plastic element which has holes that carefully align with the light sources, dyed element which can be moved thru some simple mechanical fashion in such a way that there can be careful control of the light that goes directly thru the hole in one extreme or that progressively goes less thru the hole and more thru the fluorescent dyed element until all the light goes thru the dyed element at the other extreme thus allowing for the simple mechanical adjustment of the color or hue of light from the light source.

This utility patent application claims the benefit of provisional patent application 60/993,613 with filling date Sep. 13, 2007 applicant: Eric O. Eriksson which is incorporated by reference here-in.

### BACKGROUND OF THE INVENTION

The present invention is an illumination device that allows the mechanical adjustment of the color of the output of a family of even toned bright linear lights.

The starting point has been to create a bright even tone of light like neon lighting without the downfalls of neon. Neon lighting is made by passing an electric current thru a gas filled glass tube exciting the electrons and creating the neon light effect. It has been been around for about 90 years and has had relatively few improvements. Some of its desirable attributes are its long life, even round 360 degree view light tone, even tone as viewed from any angle, the ability to factory bend the glass to create a practically unlimited range of text and images for the signage industry. Some of its negative attributes are the breakability of the glass, its difficulty to ship without breaking, its very high voltage (8,000 to 15,000 volts) that is difficult to safely contain, its tendency to cause building fires, the presence of environmentally unfriendly mercury in the tubes and the higher cost of energy to operate.

The enduring popularity of neon's bright, even, round line of light has spawned many attempts to create alternate methods to the same end. Two different families of light emitting devices that might lend themselves to this goal are flat even sources of light such as electroluminescent tape, or a string of point sources of light that have their light evened out before emitting from the fixture. Each has its challenges. A particularly useful lighting device for use in the string of point sources of light approach is the Light Emitting Diode (LED). Some good but incomplete progress has been made in this goal of a bright, even and economically viable linear light it the spirit of neon as shown in US patents: U.S. Pat. No. 6,592,238, U.S. Pat. No. 6,834,979 and U.S. Pat. No. 7,011,421 B2.

These linear light sources have become more sophisticated in how they arrive at particular colors or hues of light thru various color conversion methods using fluorescent dyes embedded in plastic. Light of specific wavelengths from the LED light source interacts with the fluorescent dyes as it passes thru the dyed medium and converts to a lower wavelength thus appearing as a different color. This technique broadens the colors that can be made with a limited number of fixed color LEDs. Custom colors can be made to suit. This is a very marketable concept. White light has benefited from this approach in that it has been difficult for the whole lighting industry to first deliver particular targeted shades of white and second to deliver them with consistent hues from batch to batch. Cooler whites are easier. Warmer whites are harder. Problems lie in the variability of the LED color output of traditional white LEDs. White LEDs are simply blue LEDs that have a fluorescent mix placed on top of the chip inside the LED this converting to white light inside the LED assembly itself. The previously mentioned approach relocates the fluorescent dyes to a second remote assembly outside the LED itself thus allowing more specific control of the final color output thru manipulation of the fluorescent dyes in the remote assembly. Also this approach allows a third party to take stock blue LEDs from an LED manufacturer and make a wider variety of white output products for less cost and in smaller batches than is possible than if the original LED manufacturer were to try to make, market, stock, and sell dozens of different white LEDs. It isn't practical.

This remote fluorescent dye approach improves many practical aspects of the delivery of different linear white light systems to the market. It has made available a broader range of whites that were difficult to make thru the currently available LEDs alone and has the potential to deliver more consistency in the hues of color but it still has some problems to overcome.

One of the technical challenges for this system is that there are several different specifications that must be kept to tight tolerances in order to deliver the same hue of white every time. One way of quantifying the hue of any particular white is by referring to its degrees Kalvin. For example an incandescent light bulb is around 2400 degrees K, a “Cool White” fluorescent tube is around 4200 degrees K, and summer sunlight is about 5500 degrees K. It is common in the industry for any one company to sell 3 different whites. A warm white around 2800 K, a medium white at 3500 K and a cool white around 6500 K. Some will try to be specific on the degree Kalvin delivered. Some will only say “warm, medium or cool” white. A major challenge to the industry is that the human eye in many cases is able to identify differences of as little as 100 K but it is often hard for companies to stay within 100 K of their targeted hue. A linear light may have 3500 K as a goal but find that its product ranges form 3000 K to 4000 K. Users will notice such a large disparity from piece to piece. If an installation receives all the fixtures in a tight range where there are no noticeable differences there is a distinct possibility that a replacement piece delivered months or years later won't match.

How does this variance occur? A couple of reasons:
1. First: LEDs are not all the same. Actually for any one color they are separated into unique “bins”, each with different qualities. There may be 3 voltage bins, 5 wavelength length bins, 4 luminous output bins. This arbitrary mix on bins would give the LED manufacturer 60 different groups of LEDs for a single color. In practice it isn't always easy for a company to repeatedly obtain the exact same bin from the 60 available to maintain consistency.
2. Second: In the remote dye approach the system is dependent on maintaining a very consistent amount of fluorescent dye thru which the LED light must pass some of which goes thru the wavelength conversion. This precise amount can vary in the manufacture of the fluorescent dye impregnated element and the width and height of the element. Batches of the fluorescent dye itself may be inconsistent as well.

### SUMMARY OF INVENTION

Any system or approach that can reduce this large number of variables and or carry the ability to change the variables further down the line in the manufacturing process would be of significant value. The current invention endeavors to do this by allowing the physical movement of a separate fluorescent dye impregnated element of varying dye concentration in relation to a fixed array of point sources of light (LEDs). The movement of the dyed element causes the fixed amount of light that emanates from each light source to pass thru differing amounts of dye thus causing differing amounts of light to engage with the fluorescent dyes thus altering the hue or degree Kalvin of the light. There are three ways to accomplish this. First the fluorescent dyed element can have the same dimensional thickness and have the concentration of dye vary. This is difficult to make. Second the element can have the same concentration of dye but have the thickness vary. This is not easy but is perhaps easier to accomplish, perhaps thru precise CNC milling that alters the thickness of a uniform thickness element. Third: the element can have more or less uniform concentration of dye and a more or less uniform thickness but can have holes drilled in it in the same pattern as the LEDs so that when the element is moved in relation to the LED assembly the amount of light that passes thru dye alters depending on if the holes line up with the LEDs, the holes miss the LEDs altogether or something in between. The end result is that by moving the element a slight amount it can vary the degrees Kalvin across a narrow finely tuned spectrum or across a wide range all depending on the size and shape of the hole in the uniform dyed element and how far if is move off center from the LED.

From a practical point of view it is only important that all the holes align with all the corresponding LEDs and that the dyed element has substantial contact with the top of the LEDs so that there is little or no light leakage from the LEDs around the element. That would “short circuit” the system. This approach essentially removes the variability issue in the Kalvin output due to inconsistent concentration of fluorescent dye and to some degree addresses the variable of the LED binning issue. The hue binning variable can be reduced if not eliminate by a second step in this system and that is by having several different elements mixed with a range of different fluorescent dyes designed to give several choices of control over what ever hue bin of LED is being used. Five different mixes of elements might cover all possible hue bins per color. This places the actual time of adjustment to deal with differently supplied hues of LEDs late in the manufacturing process thus saving substantial cost and greatly improving color accuracy.

So far the assumption in this application has been that this mechanical adjustable color conversion device is applied to linear light systems but it can apply just as well to a single point source of light as well as an X Y coordinate array of point sources of light or in a radial array where say 6 LEDs are oriented in a circle around a single pivot point and the physical adjustment is accomplished thru a twist action. We have also focused the discussion on conversion of blue LED light to White light via a primarily orange fluorescent dyed element. The system can also apply as well to other colors for example shining blue light thru a primarily red fluorescent dye element will deliver a very nice Magenta color. This magenta color could be tuned with the use of the described invention to bring forth a purple which is hard to hit and requires very careful fine tuning. Lastly the discussions above have focused on LEDs as the preferred light source but do not mean that to exclude other useful light sources using the same basic principles.

### BRIEF EXPLANATION OF THE DRAWINGS

FIG. 2A shows a section of one possible illumination device that can utilize this color change concept

FIG. 5A shows two sections a plan and an isometric of the movable dyed element aligned directly above the light sources

FIG. 5B shows the same as 5A but with the movable dyed element shifted 50% out of phase with the light sources

FIG. 5C shows the same as 5A but with the movable dyed element shifted 100% out of phase with the light sources.

FIGS. 6A, 6B and 6C show sections of the same principles as FIGS. 5A, 5B and 5C but with flat arrays of light sources instead of a linear approach.

FIG. 7 shows a plan view of an array of light sources.

FIG. 8 shows an isometric of the light source circuit board below a corresponding dyed array with aligning holes.

### DETAILED DESCRIPTION OF INVENTION

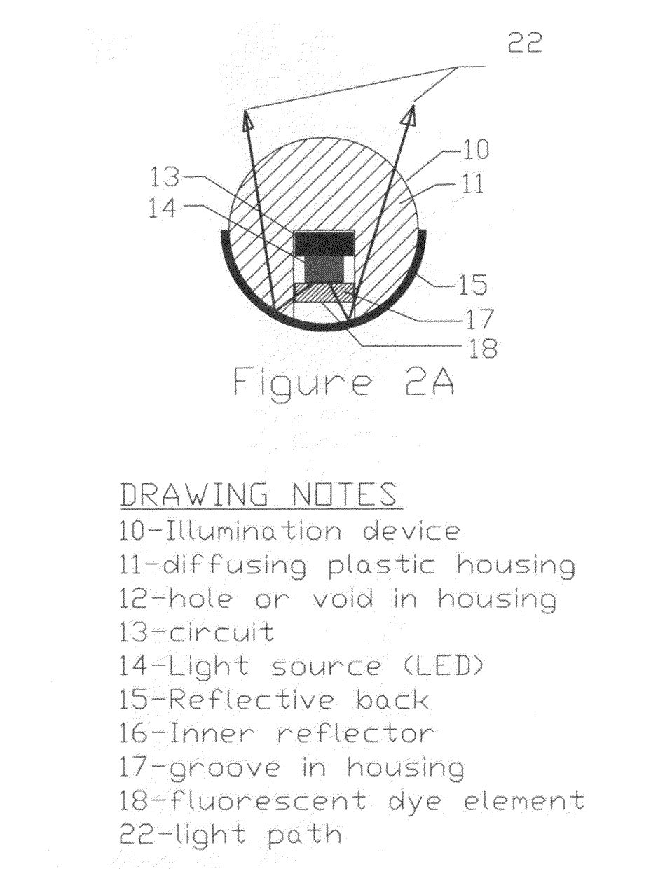

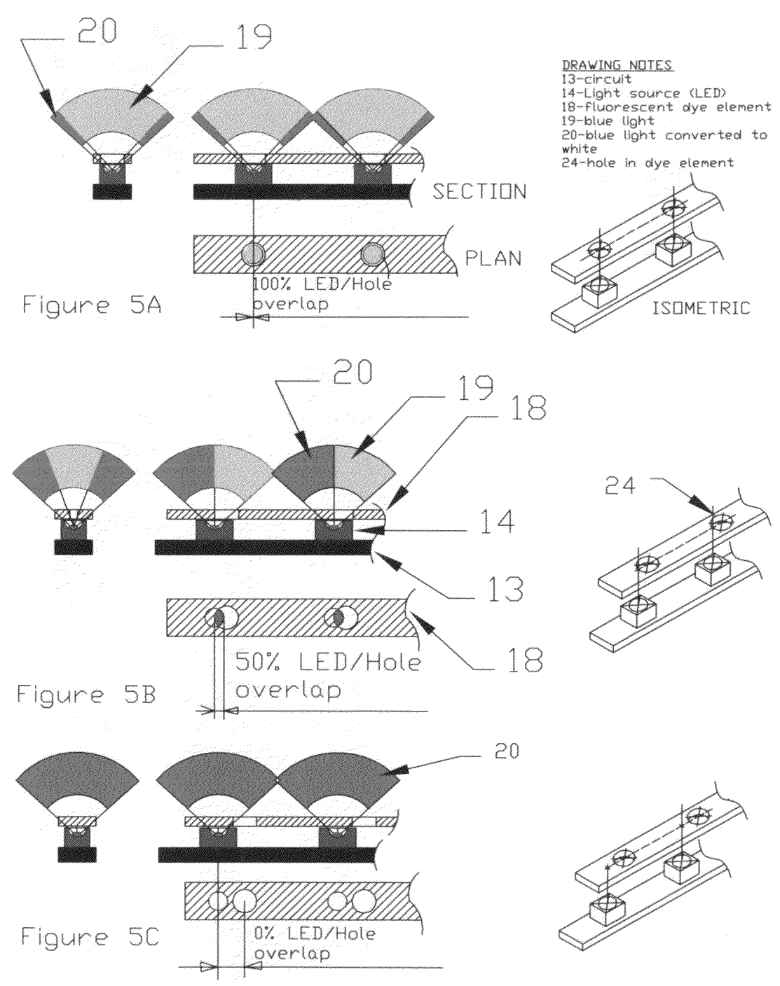

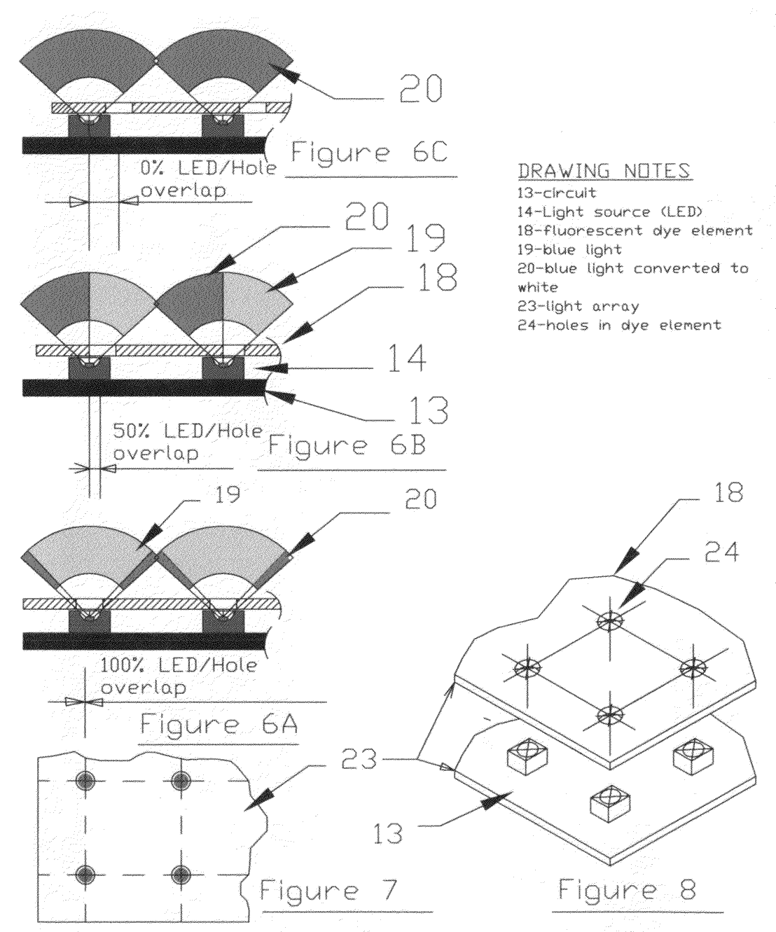

The invention involves the mechanical movement of a fluorescent dye impregnated element with variable densities or volumes of dye against a light source to adjust the amount of fluorescent dye that interacts with the light with the end goal of carefully controlling the final light hue output. This dyed element may be made of clear acrylic. FIGS. 5A, 5B and 5C show details of how the present invention works in a linear lighting situation. FIG. 2A shows a cross section thru an exemplary linear light system incorporating the invention. This is but one of many possible useful linear light systems that could benefit from this concept. FIGS. 6A, 6B and 6C show details on how the present invention works in a flat array.

In FIGS. 5A, 5B and 5C we see a flat rectangular bar of fluorescent dye impregnated plastic 18 that sits on top of a series of evenly spaced surface mounted blue light LEDs 14 that are mounted on a circuit board 13 (any color LED may be used). The bar is snug to the top of the LEDs but must be free to move laterally. The LEDs emit light in a round or oval pattern (or any other geometric pattern like a square or rectangle) upward in a more or less 120 degree spread. The bar in this particular rendition of the invention has holes that align with the LED spacing. The holes are of equal or greater diameter than the lens of the LEDs.

In FIG. 5A the bar holes align right above the centers of the LED lenses. In this condition the vast majority of the blue light from the LED passes thru the hole in the bar therefore very little of the blue light interacts with the fluorescent dyes in the bar thus the light exiting the system is essentially the same blue that exited the LED.

In FIG. 5B we see the bar has been slid slightly to the right of the center of the LEDs thus causing more of the blue light exiting the LEDs to go thru the bar and interact with the dyes. This causes some of the light to change wavelength so the resultant light that exits the system starts to appear cool white. As the bar and its holes are moved further laterally more of the bar will end up in front of the light thus causing more dye to interact and the resultant white light will get warmer in hue until the hole in bar has completely passed the LED light source as in FIG. 5C. These figures show a linear light application.

FIG. 5C shows all the light from the LED going thru the bar thus causing the maximum amount of interaction between the blue light and the orange dyes resulting in the warmest white light that the system will allow.

Thru simple mechanical means like movement of a lever, the twisting of a screw or the turning of a nut the hue of light can thus be tuned back and forth until the desired hue is achieved then locked in place. Previously the industry relied on the ordering of thousands of linear feet of extruded plastic with fluorescent dye of a certain formula. If the formula was off for any reason there was no way to adjust afterward.

FIG. 2A shows how the invention might reside if oriented in a linear light dispersing system 10. The LEDs 14 adhered to the circuit board 13 sit in a groove in 17 in a diffusing plastic housing 11. The fluorescent dye impregnated bar (element) 18 is snug against the face of the LEDs 14 and is free to slide laterally against them. The light 22 exits the LED changes wavelength as it passes thru the bar, bounces off the back reflector and exits out the front of the illumination device thru the diffusing plastic housing 11 as an even diffused light. This is just one of many illumination devices where this invention will work.

In FIGS. 6A, 6B, 6C, 7 and 8 we see the same occurrences but spread out in an array (two axes). The adjustment would be made by sliding the dyed sheet element in any direction as long as there is no rotation.

What is claimed is:

1. A mechanically adjustable color conversion system for illumination devices comprising of:
Individually oriented light sources;
with a fluorescent dye impregnated plastic element above the light source that varies in dye concentration or dye volume and that has holes that align with the light sources;
wherein the holes are aligned on top of light sources in such a way that the dyed element can be dynamically moved laterally across the top of the light sources so that the holes in the element move in or out of alignment with the centers of the light sources causing more or less light from the light source (s) to interact with the dyed element thus allowing for the change and control of the hue of the light output.

6. The mechanically adjustable color conversion system of claim 1 in which said light sources are light emitting diodes.

7. The mechanically adjustable color conversion system of claim 1 in which the light sources are oriented in a linear fashion.

8. The mechanically adjustable color conversion system of claim 1 in which the light sources and dyed element are oriented in an array.

9. The mechanically adjustable color conversion system of claim 1 in which the light sources and dyed element are oriented radially.

10. The mechanically adjustable color conversion system of claim 9 in which the dynamic movement is in a radial fashion.
